(19) United States
(12) Patent Application Publication
(10) Pub. No.: US 2008/0109227 A1
(43) Pub. Date: May 8, 2008

(54) Voice Control System and Method for Controlling Computers

(75) Inventors: Hsin-Mao Shen, Taipei Hsien (TW); Chao-Hsuan Hsueh, Taipei Hsien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ATEN INTERNATIONAL CO., LTD., Taipei Hsien (TW)

(21) Appl. No.: 11/556,861

(22) Filed: Nov. 6, 2006

(51) Int. Cl. G10L 11/00; G06F 3/033

(52) U.S. Cl. 704/275; 345/163

(57) ABSTRACT

The voice control system includes a KVM switch and an audio device. The audio device receives a voice command, transforms the voice command into a command signal and outputs the command signal to the KVM switch for controlling the KVM to manage computers. A method for managing the computers by a voice command is also disclosed.

### BACKGROUND

1. Field of Invention

The present invention relates to a KVM switch. More particularly, the present invention relates to a KVM switch capable of controlling computers with an audio signal.

2. Description of Related Art

Computers and their peripherals have become very popular with the rapid development in information technology. Each computer is typically equipped with one set of user interface devices, which may include a keyboard, a mouse and a monitor. If several computers are being used, a keyboard-video-mouse (KVM) switch is proposed to be used, which utilizing at least one set of user interface devices to manage several computers and their peripherals.

As mentioned, a keyboard is typically used to input commands for controlling computers. For more convenient operations, hot keys or key combinations are designed to execute common commands. For example, “ctrl-c” is usually pressed to copy the selected objects. There are many kinds of customized hot keys for users to input commands quickly.

The skill in the prior art is to install the software in the computer so that the users can input commands by speaking to directly control the computer with software. The users can consequently save much time on using the keyboard or the mouse.

### SUMMARY

It is an aspect of the present invention to provide a KVM switch capable of managing computers with an audio signal.

In accordance with one embodiment of the present invention, the KVM switch includes a control unit for data processing and controlling the KVM switch and an audio recognition module for receiving an audio signal, transforming the audio signal into a command signal and outputting the command signal to the control unit for controlling the KVM switch or the plurality of computers.

It is another aspect of the present invention to provide a voice control system capable of managing computers by a voice command.

In accordance with another embodiment of the present invention, the voice control system includes a KVM switch managing the plurality of computers and an audio device for receiving a voice command, transforming the voice command into a command signal and outputting the command signal to the KVM switch for controlling the KVM switch or the plurality of computers.

It is still another an aspect of the present invention to provide a method of using a voice command to manage computers for managing the computers by the voice command.

In accordance with still another embodiment of the present invention, the method includes converting the voice command into an audio signal by an audio console, converting the audio signal into a command signal according to a database by a signal processor, wherein at least one relationship between the audio signal and the command signal is stored in the database, and transmitting the command signal to a control unit for controlling a KVM switch managing a plurality of computers.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the preferred embodiment, with reference made to the accompanying drawings as follows:

FIG. 1 is a block diagram showing a KVM switch according to one embodiment of the present invention; and

FIG. 2 is a block diagram showing a voice control system according to one embodiment of the present invention; and

FIG. 3 shows a process of managing computers by a voice command.

### DESCRIPTION OF THE PREFERRED EMBODIMENTS

Detailed illustrative embodiments of the present invention are disclosed herein. However, specific details disclosed herein are merely representative for purposes of describing exemplary embodiments of the present invention. This invention may, however, be embodied in many alternate forms and should not be construed as limited to the embodiments set forth herein.

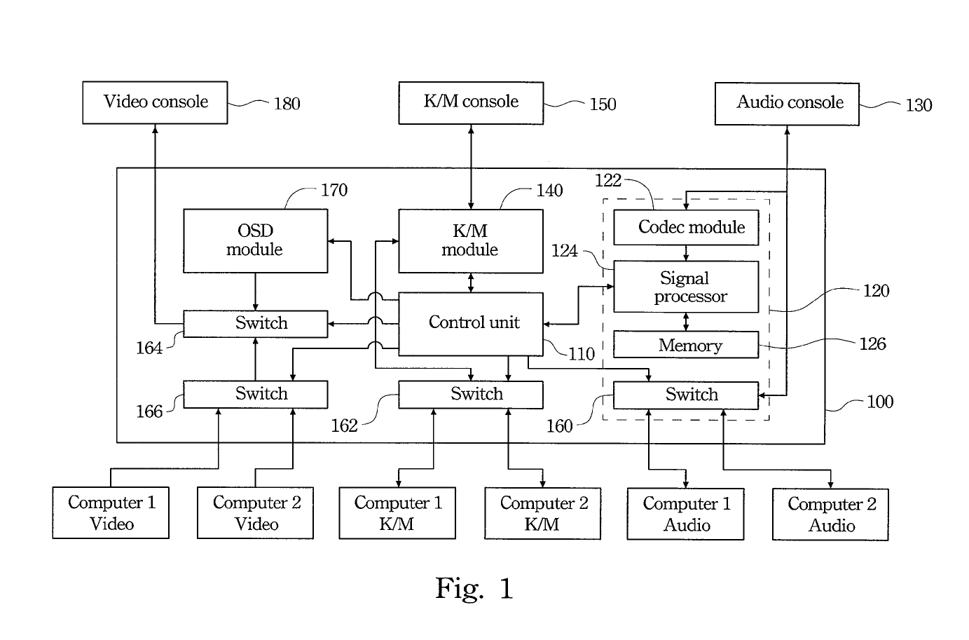

FIG. 1 is a block diagram showing a KVM switch according to one embodiment of the present invention. Referring to FIG. 1, the KVM switch 100 is capable of managing plural computers, for example, Computer 1 and Computer 2, and includes a control unit 110 and an audio recognition module 120. The control unit 110 processes data and controls the KVM switch 100, wherein the control unit 110 may be a central processing unit or a micro controller unit. The audio recognition module 120 receives an audio signal from an audio console 130, transforms the audio signal into a command signal and outputs the command signal to the control unit 110 for controlling Computer 1, Computer 2 or the KVM switch 100.

The audio recognition module 120 includes a codec module 122, a signal processor 124 and a memory 126, wherein the signal processor 124 may be a digital signal processor (DSP) or an audio recognition IC for processing audio signals. After the codec module 122 receives the audio signal from the audio console 130, the codec module 122 converts the audio signal into a digital audio signal and transmits the digital audio signal to the signal processor 124. The signal processor 124 receives the digital audio signal and processes the digital audio signal. At least one digital audio signal processed by the signal processor 124 is stored in the memory 126 as a database for recognizing the subsequent received digital audio signals from the codec module 122, wherein the database can be established by a user training process. For example, the user may be asked to follow the instructions and read the vocabularies or sentences displayed on the screen. So the subsequent received digital audio signals have to be recognized during an audio recognition procedure, such as dynamic time warping (DTW), to be converted into the command signal. In other words, the signal processor 124 converts the digital audio signal into the command signal according to the database. After that, the signal processor 124 transmits the command signal to the control unit 110.

The KVM switch 100 also includes a K/M module 140. The control unit 110 transmits the command signal to the K/M module 140 after receiving the command signal. The K/M module 140 receives the command signal, and translates the command signal into a computer recognizable command, wherein the computer recognizable command may include a keyboard signal, and the keyboard signal can be a left, right, up, down, enter, backspace, ctrl-c, ctrl-v, ctrl-x signal, or any other keyboard signals. The K/M module 140 transmits the computer recognizable command to Computer 1 or Computer 2 for controlling Computer 1 or Computer 2 as illustrated in FIG. 1. The K/M module 140 can also receive keyboard/mouse signals from a keyboard/mouse (K/M) console 150 and convert the keyboard/mouse signals into the computer recognizable command for controlling Computer 1 or Computer 2. The commands may be transmitted to more computers depending on the configuration of the KVM switch.

The KVM switch 100 can further include a switch 160 controlled by the control unit 110, such that the audio signal from the audio console 130 can be directly transmitted to either Computer 1 or Computer 2 through the switch 160. The audio signal of either Computer 1 or Computer 2 can be transmitted to the audio console 130 through the switch 160 as well. Similarly, the KVM switch 100 can further include a switch 162 controlled by the control unit 110, such that the computer recognizable command from the K/M module 140 can be transmitted to either Computer 1 or Computer 2 through the switch 162.

Moreover, the KVM switch 100 can also include an on-screen display (OSD) module 170, wherein the on-screen display module 170 is also controlled by the control unit 110 and outputs a video signal to a Video console 180 so as to display the command signal on the Video console 180. So the on-screen display module 170 is also capable of displaying instruction signals on the Video console 180 during the user training process to guide the user through out the training process. Similarly, the KVM switch 100 may also include a 10 switch 164 controlled by the control unit 110, such that the video signal from the on-screen display module 170 or a video signal from either Computer 1 or Computer 2 through another switch 166 controlled by the control unit 110 can be transmitted to the Video console 180 through the switch 164.

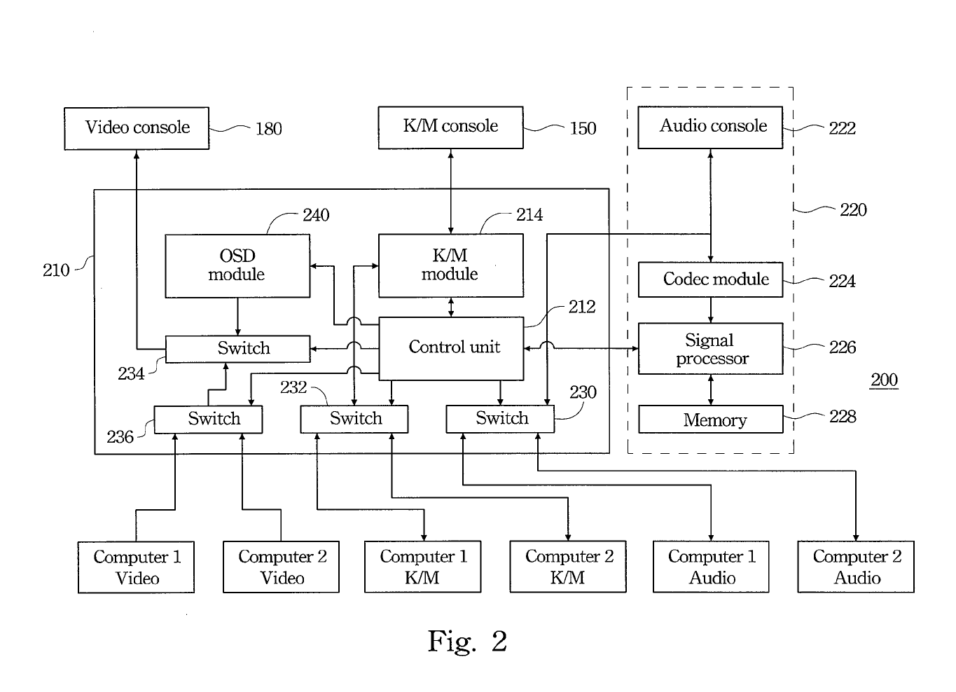

FIG. 2 is a block diagram showing a voice control system according to another embodiment of the present invention. Referring to FIG. 2, the voice control system 200 is capable of managing Computer 1 and Computer 2 by a voice command as well. The voice control system 200 includes a KVM switch 210 and an audio device 220. The audio device 220 receives the voice command, transforms the voice command into a command signal and outputs the command signal to the KVM switch 210 for controlling Computer 1, Computer 2 or the KVM switch 210. The KVM switch 210 includes a control unit 212 and a K/M module 214. The control unit 212 processes data and controls the KVM switch 210, wherein the control unit 212 can be a central processing unit or a micro controller unit.

The audio device 220 includes an audio console 222, a codec module 224, a signal processor 226 and a memory 228, wherein the signal processor 226 may be a digital signal processor (DSP) or an audio recognition IC for processing audio signals. After the audio console 222 receives the voice command from the user, the audio console 222 converts the voice command into an audio signal and transmits the audio signal to the codec module 224. The codec module 224 receives the audio signal and converts the audio signal into a digital audio signal, and transmits the digital audio signal to the signal processor 226. The signal processor 226 receives the digital audio signal and processes the digital audio signal. At least one digital audio signal processed by the signal processor 226 is stored in the memory 228 as a database for recognizing the subsequent received digital audio signals from the codec module 224, wherein the database can be established by a user training process. So the subsequent received digital audio signals have to be recognized during the audio recognition procedure mentioned above to be converted into the command signal. In other words, the signal processor 226 converts the digital audio signal into the command signal according to the database. After that, the signal processor 226 transmits the command signal to the control unit 212.

The control unit 212 transmits the command signal to the K/M module 214 after receiving the command signal. The K/M module 214 receives the command signal, and translates the command signal into a computer recognizable command, wherein the computer recognizable command may include a keyboard signal, and the keyboard signal can be the left, right, up, down, enter, backspace, ctrl-c, ctrl-v, ctrl-x or any other keyboard signals as well. The K/M module 214 transmits the computer recognizable command to Computer 1 or Computer 2 for controlling Computer 1 or Computer 2. The K/M module 214 can also convert the received keyboard/mouse signals from the K/M console 150 into the computer recognizable command for controlling Computer I or Computer 2. The commands may be transmitted to more computers depending on the configuration of the KVM switch.

The KVM switch 210 may further include a switch 230 controlled by the control unit 212, such that the audio signal from the audio console 222 can be directly transmitted to either Computer 1 or Computer 2 through the switch 230. The audio signal of either Computer 1 or Computer 2 can be transmitted to the audio console 222 through the switch 230 as well. Similarly, the KVM switch 210 can further include a switch 232 controlled by the control unit 212, such that the computer recognizable command from the K/M module 214 can be transmitted to either Computer 1 or Computer 2 through the switch 232.

Moreover, the KVM switch 210 can also include an on-screen display module 240, wherein the on-screen display module 240 is also controlled by the control unit 212 and outputs a video signal to the Video console 180 so as to display the command signal on the Video console 180. So the on-screen display module 240 is also capable of displaying instruction signals on the Video console 180 during the user training process to guide the user through out the training process. Similarly, the KVM switch 210 can also include a switch 234 controlled by the control unit 212, such that the video signal from the on-screen display module 240 or a video signal from either Computer 1 or Computer 2 through another switch 236 controlled by the control unit 212 can be transmitted to the Video console 180 through the switch 234.

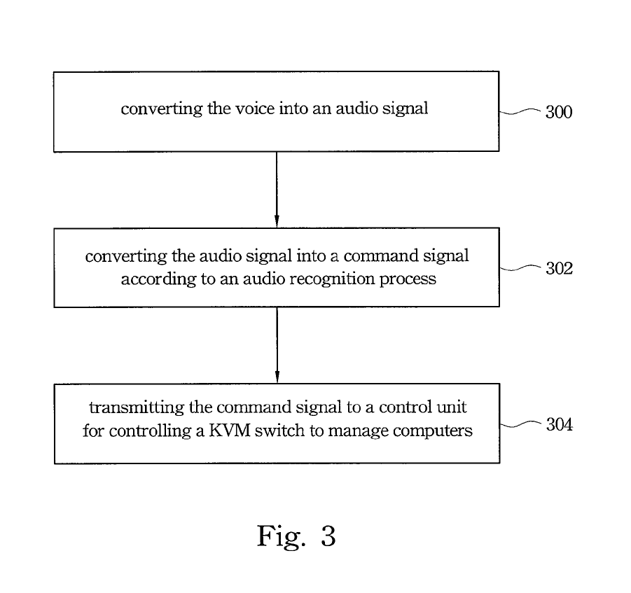

FIG. 3 shows a process of managing computers by a voice command. Referring to FIG. 2 and FIG. 3, in the step 300, the voice command is converted into an audio signal by the audio console 222. Then in the step 302, the audio signal is converted into a command signal according to an audio recognition process by the codec module 224 and the signal processor 226. In the last step 304, the command signal is transmitted to the control unit 212 for controlling the KVM switch 210 to manage the computers. Therefore, the computers can be managed by the command signal into which the voice of the user's speaking is converted.

The control unit 212 can be a central processing unit or a micro controller unit as well. Further, the KVM switch 210 can include the K/M module 214 for processing keyboard/mouse signals from the keyboard/mouse console 150. The K/M module 214 also receives the command signal and translates the command signal into a computer recognizable command, wherein the computer recognizable command includes the keyboard signal and the keyboard signal can be the left, right, up, down, enter, backspace, ctrl-c, ctrl-v or ctrl-x signal as well.

Furthermore, the KVM switch 210 can also include the on-screen display module 240, wherein the on-screen display module 240 is also controlled by the control unit 212 and outputs a video signal to the Video console 180 so as to display the command signal on the Video console 180.

Therefore, the user can input the command into the computer to control the computer more conveniently. Besides, the user can also manage the computers only by speaking without using the keyboard or the mouse according to the present invention.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A KVM switch for managing a plurality of computers, the KVM switch comprising:
a control unit for data processing and controlling the KVM switch; and
an audio recognition module for receiving an audio signal, transforming the audio signal into a command signal and outputting the command signal to the control unit for controlling the KVM switch or the plurality of computers.

2. The KVM switch of claim 1, wherein the control unit is a central processing unit or a micro controller unit.

3. The KVM switch of claim 1, further comprising:
a K/M module for processing keyboard/mouse signals, wherein the KIM module receives the command signal and translates the command signal into a computer recognizable command.

4. The KVM switch of claim 3, wherein the computer recognizable command comprises a keyboard signal.

5. The KVM switch of claim 4, wherein the keyboard signal is a left, right, up, down, enter, backspace, ctrl-c, ctrl-v or ctrl-x signal.

6. The KVM switch of claim 1, wherein the audio recognition module comprises:
a codec module for converting the audio signal into a digital audio signal;
a signal processor for processing the digital audio signal and converting the digital audio signal into the command signal; and
a memory for storing at least one processed digital audio signal as a database, wherein the signal processor converts the digital audio signal into the command signal according to the database.

7. The KVM switch of claim 6, wherein the database is established by a training process of the audio recognition module.

8. The KVM switch of claim 7, further comprising:
an on-screen display module which is capable of guiding a user through out the training process.

9. The KVM switch of claim 1, further comprising:
an on-screen display module controlled by the control unit and outputting a video signal so as to display the command signal outputted from the audio recognition module on a video console.

10. A voice control system for managing a plurality of computers, the voice control system comprising:
a KVM switch; and
an audio device for receiving a voice command, transforming the voice command into a command signal and outputting the command signal to the KVM switch for controlling the KVM switch or the plurality of computers.

11. The voice control system of claim 10, wherein the KVM switch comprises:
a control unit for data processing and controlling the KVM switch; and
a KIM module for processing keyboard/mouse signals, wherein the KIM module receives the command signal and translates the command signal into a computer recognizable command.

12. The voice control system of claim 11, wherein the control unit is a central processing unit or a micro controller unit.

13. The voice control system of claim 11, wherein the computer recognizable command comprises a keyboard signal.

14. The voice control system of claim 13, wherein the keyboard signal is a left, right, up, down, enter, backspace, ctrl-c, ctrl-v or ctrl-x signal.

15. The voice control system of claim 10, wherein the audio device comprises:
an audio console for converting the voice command into an audio signal;
a codec module for converting the audio signal into a digital audio signal;
a signal processor for processing the digital audio signal and converting the digital audio signal into the command signal; and
a memory for storing at least one processed digital audio signal as a database, wherein the signal processor converts the digital audio signal into the command signal according to the database.

16. The voice control system of claim 15, wherein the database is established by a training process of the audio device.

17. The voice control system of claim 16, wherein the KVM switch further comprises an on-screen display module which is capable of guiding a user through out the training process.

18. The voice control system of claim 11, wherein the KVM switch further comprises:
an on-screen display module controlled by the control unit and outputting a video signal so as to display the command signal outputted from the audio device on a video console.

19. A method for managing a plurality of computers by a voice command, comprising:
converting the voice command into an audio signal;
converting the audio signal into a command signal according to an audio recognition process; and
transmitting the command signal to a control unit for controlling a KVM switch to manage the plurality of computers.

20. The method of claim 19, wherein the control unit is a central processing unit or a micro controller unit.

21. The method of claim 19, wherein the KVM switch further comprises a K/M module for processing keyboard/mouse signals, wherein the K/M module receives the command signal and translates the command signal into a computer recognizable command.

22. The method of claim 21, wherein the computer recognizable command comprises a keyboard signal.

23. The method of claim 22, wherein the keyboard signal is a left, right, up, down, enter, backspace, ctrl-c, ctrl-v or ctrl-x signal.

24. The method of claim 19, wherein the KVM switch further comprises:
an on-screen display module controlled by the control unit and outputting a video signal so as to display the command signal on a video console.
